(19) United States
(12) Patent Application Publication
(10) Pub. No.: US 2024/0288682 A1
(43) Pub. Date: Aug. 29, 2024

(54) SCANNING DEVICE OPERATED USING ELECTROMAGNETIC FORCE

(71) Applicant: CITYGEAR Co., Ltd., Seoul (KR)

(72) Inventor: Youngsoon Choi, Seoul (KR)

(21) Appl. No.: 18/139,569

(22) Filed: Apr. 26, 2023

(30) Foreign Application Priority Data
Feb. 24, 2023 (KR) 10-2023-0025019

(51) Int. Cl. G02B 26/10; G01S 7/481; G02B 26/08

(52) U.S. Cl. CPC G02B 26/101; G01S 7/4817; G02B 26/085

(57) ABSTRACT

Provided is a scanning device driven with electromagnetic force, including a mirror configured to reflect incident light, a first rotating shaft connected to both ends of the mirror in a radial direction of the mirror and configured to allow the mirror to be rotated around an axis parallel to the radial direction, a first support connected to the first rotating shaft and configured to support the mirror through the first rotating shaft, a first permanent magnet coupled to the mirror and magnetized in the radial direction of the mirror, and a first electromagnetic field generator configured to generate a first electromagnetic field with respect to the first permanent magnet, wherein a polarity of the electromagnetic field changes according to a first driving signal.

### CROSS-REFERENCE TO RELATED APPLICATION

This application claims priority under 35 U.S.C. § 119 to Korean Patent Application No. 10-2023-0025019, filed in the Korean Intellectual Property Office on Feb. 24, 2023, the entire contents of which are hereby incorporated by reference.

### TECHNICAL FIELD

The present disclosure relates to a scanning device operated using electromagnetic force, and more particularly, to a scanning device driven with electromagnetic force generated with a permanent magnet coupled to a mirror that reflects input light and magnetized in a radial direction of the mirror.

### BACKGROUND

A scanning device capable of outputting and inputting light using an optical element can be used in various technical fields. The scanning device may be implemented with micro-electro-mechanical system (MEMS) technology and is being released as a miniaturized and lightweight product, and used in various applications such as light detection and ranging (LIDAR) sensors, head-up displays, scanning projectors, and laser printers.

The scanning device may include a scanning mirror capable of achieving scanning speed, scanning range, angular displacement, and tilting angle which are set according to application fields. The scanning mirror may be configured to direct an incident light beam to a one-dimensional or two-dimensional area so as to form an image or collect data.

A LIDAR system using a scanning device may emit a laser onto an object and analyze laser light reflected from the object to measure a distance to the object, direction, speed, and the like. A scanning device used in a LIDAR system may be classified into a uniaxial type, a biaxial type, or a rotational type according to its drive type. For example, the uniaxial or biaxial scanning device may be driven with electromagnetic or electrostatic force, or may be driven using a piezo-electric element or the like. In addition, the rotational scanning device may be driven by an electro-mechanical device such as a motor. Since various elements and electric circuits disposed in the scanning device driven by the motor are continuously subjected to centrifugal force according to rotation, there is a problem in that the durability of the corresponding elements may be deteriorated, limiting the scanning speed in a specific direction.

In recent years, according to the miniaturization of scanning devices, a method for driving a mirror with electrostatic or electromagnetic force is widely used, in which the mirror may use MEMS technology of depositing a metal material on a semiconductor wafer. In this case, since the size of the scanning device is limited, electrostatic force and the like for driving the MEMS mirror may be insufficient. Therefore, the MEMS mirror is manufactured in a fairly small size so as to be driven at high speed even with a small force, and in order to reflect the light incident on the small-sized mirror without loss, it requires a collimating optical system with a complicated structure to generate light having a beam size smaller than that of the corresponding mirror. In addition, due to structural limitations of the scanning device using the MEMS mirror, the driving range of the mirror may be limited. Accordingly, an additional lens (e.g., a wide angle lens) may be required to expand an emission range of the light that is reflected by the mirror in a small angular range. Due to the structural limitations of the scanning device using MEMS mirror, there is a problem in that cost significantly increases in order to manufacture a scanning device including a large-sized mirror.

### SUMMARY

In order to solve the problems discussed above, the present disclosure provides a scanning device driven with electromagnetic force.

The scanning device driven with electromagnetic force may include a mirror configured to reflect incident light, a first rotating shaft connected to both ends of the mirror in a radial direction of the mirror and configured to allow the mirror to be rotated around a first axis parallel to the radial direction, a first support connected to the first rotating shaft and configured to support the mirror through the first rotating shaft, a first permanent magnet coupled to the mirror and magnetized in the radial direction of the mirror, and a first electromagnetic field generator configured to generate a first electromagnetic field with respect to the first permanent magnet, in which a polarity of the first electromagnetic field changes according to a first driving signal.

The first support may include a mirror support connected to the first rotating shaft and supporting the mirror connected to the first rotating shaft, and an opening for receiving the first electromagnetic field generator disposed below the mirror.

The scanning device may further include a second rotating shaft connected to both ends of the first support in a direction orthogonal to the radial direction of the mirror and configured to allow the first support to be rotated around a second axis parallel to the direction orthogonal to the radial direction of the mirror, a second support connected to the second rotating shaft and configured to support the first support through the second rotating shaft, a second permanent magnet coupled to a lower end of the first support and magnetized in the direction orthogonal to the radial direction of the mirror, and a second electromagnetic field generator configured to generate a second electromagnetic field with respect to the second permanent magnet, in which a polarity of the second electromagnetic field changes according to a second driving signal.

The second rotating shaft may include a bearing configured to be rotatable with respect to the second support, and an elastic member configured to provide the first support with a restoring force torque.

The elastic member may include at least one of: a spring; or a polyamide film.

The first electromagnetic field generator may include a core having a central axis orthogonal to a surface of the first permanent magnet, and a coil configured to be wound around the core, wherein the first driving signal is applied to the coil.

The scanning device may further include a laser light source configured to emit laser light toward the mirror.

The scanning device may further include a controller configured to generate the first driving signal to cause an electromagnetic field toward the first permanent magnet. A polarity of the electromagnetic field may change selectively.

The first rotating shaft may include an elastic member (e.g., a spring, a polyamide film, etc.) configured to provide the mirror with a restoring force torque.

The scanning device may further include a third permanent magnet magnetized in a direction orthogonal to the radial direction of the mirror, a third electromagnetic field generator configured to generate a third electromagnetic field with respect to the third permanent magnet, in which a polarity of the third electromagnetic field changes according to a third driving signal, a connection part fixedly connecting the third permanent magnet and the first support, a third rotating shaft connected to one end of the first support in the direction orthogonal to the radial direction of the mirror and configured to allow the first support to be rotated, a fourth rotating shaft connected to one end of the third permanent magnet in the direction orthogonal to the radial direction of the mirror and configured to allow the third permanent magnet to be rotated, and a third support connected to the third rotating shaft and the fourth rotating shaft and configured to support the third permanent magnet and the first support.

The scanning device may further include an angle detection unit connected to one end of the second rotating shaft and configured to detect a rotation angle of the second rotating shaft and a magnetic encoder configured to control driving of the second rotating shaft based on the detected rotation angle of the second rotating shaft.

The second support may include a reference rod for angle zero point adjustment, wherein the reference rod is spaced apart from the first support and protrudes upward from a lower end of the second support. The magnetic encoder may be configured to set, as a zero point, the rotation angle of the second rotating shaft when the first support contacts the reference rod (e.g., for angle zero point adjustment).

A LIDAR scanning device may be provided, which may include the scanning device including the characteristics according to various examples described above, and a reception unit configured to receive light reflected from an object, if the light reflected from the scanning device (e.g., the mirror) is emitted to the object.

According to various examples of the present disclosure, by using the electromagnetic field generator that generates electromagnetic field with varying polarity with respect to the permanent magnet coupled to one side of the mirror, it is possible to drive the mirror with a larger driving force than the related scanning device that uses the MEMS mirror. Accordingly, the scanning device can efficiently drive a mirror having a large area at high speed.

According to various examples of the present disclosure, the uniaxial scanning device can be implemented by using the electromagnetic field generator that generates an electromagnetic field of which polarity changes with respect to the permanent magnet coupled to one side of the mirror. Therefore, the scanning device can be miniaturized through a simple manufacturing process, and a control circuit for driving the mirror can be simplified.

According to various examples of the present disclosure, the rotating shaft for rotatably connecting the mirror to the support can be formed of a polyamide film. Therefore, even when the size of a beam of light incident on the mirror exceeds the size of the mirror, reflection of light by the rotating shaft connected to the mirror can be reduced. In addition, since light is reflected only by the mirror, a collimating optical system for adjusting the size of the beam of light can be simplified.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a perspective view showing a configuration of a scanning device driven with electromagnetic force;

FIG. 2 is a perspective view showing a detailed configuration of a scanning device for driving a mirror in a biaxial direction with electromagnetic force;

FIG. 3 is a graph showing an example of a driving signal generated by a controller to drive a scanning device in a biaxial direction;

FIG. 4 is a perspective view showing a detailed configuration of a scanning device for driving a mirror in a uniaxial direction with electromagnetic force;

FIG. 5 is a perspective view showing a configuration of a mirror included in a scanning device and a permanent magnet coupled to the mirror;

FIGS. 6A and 6B are diagrams illustrating a method for driving a mirror in a uniaxial direction with electromagnetic force in a scanning device;

FIG. 7 is a perspective view showing a configuration of a scanning device driven with electromagnetic force; and

FIG. 8 is a perspective view showing an example of a configuration for controlling a second rotating shaft of a scanning device.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of the embodiments, duplicate descriptions of the same or corresponding elements may be omitted. However, even if descriptions of elements are omitted, it is not intended that such elements are not included in any example.

Advantages and features of the disclosed examples and methods of accomplishing the same will be apparent by referring to examples described below in connection with the accompanying drawings. However, the present disclosure is not limited to the embodiment(s) disclosed below, and may be implemented in various different forms, and the embodiment(s) is/are merely provided to make the present disclosure complete, and to fully disclose the scope of the invention to those skilled in the art to which the present disclosure pertains.

The terms used in the present disclosure will be briefly described prior to describing the disclosed embodiment(s) in detail.

The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms.

Further, throughout the description, when a portion is stated as “comprising (including)” an element, it intends to mean that the portion may additionally comprise (or include or have) another element, rather than excluding the same, unless specified to the contrary. In addition, the statement “A and/or B” as used herein means “A”, or “B”, or “A and B”.

Prior to describing various features of the present disclosure, it is to be noted that the upper direction of the drawing may be referred to as “upper portion” or “upper side” of the configuration shown in the drawing, and the lower direction may be referred to as “lower portion” or “lower side”. In addition, in the drawings, a portion between the upper and lower portions of the configuration shown in the drawings, or a portion other than the upper and lower portions may be referred to as “side portion” or “side”.

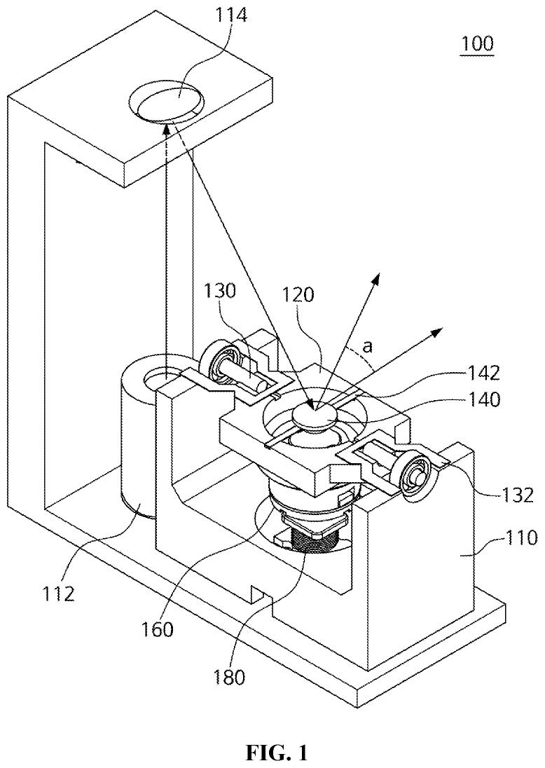

FIG. 1 is a perspective view showing a configuration of a scanning device driven with electromagnetic force.

A scanning device 100 driven with electromagnetic force may include a mirror 140 configured to reflect incident light, a first rotating shaft 142 connected to both ends of the mirror 140 in the radial direction and rotatably supporting the mirror 140, and a first support 120 connected to the first rotating shaft 142 and configured to support the mirror 140 through the first rotating shaft 142. In this case, the first rotating shaft 142 may be formed of a spring or a polyamide film configured to provide restoring force torque to the mirror 140. In addition, the scanning device 100 may further include a first electromagnetic field generator (not shown) that generates an electromagnetic force directed toward the mirror 140 or an electromagnetic force directed away from the mirror 140, according to a driving signal.

A first permanent magnet (not shown) magnetized in a radial direction of the mirror 140 may be coupled to a lower end of the mirror 140. In addition, the first electromagnetic field generator may be disposed in an opening of the first support 120 and below the mirror 140. In this configuration, the first electromagnetic field generator may generate an electromagnetic force directed toward the first permanent magnet coupled to the lower end of the mirror 140, or may generate an electromagnetic force directed away from the first permanent magnet, according to a driving signal input from the controller (not shown). That is, the first electromagnetic field generator may generate an electromagnetic field directed toward the first permanent magnet, in which the polarity of the electromagnetic field changes according to the driving signal. As a result, the mirror 140 may be rotated clockwise or counterclockwise about the first rotating shaft 142.

The scanning device 100 may further include a light source 112 configured to generate light such as laser light. If the light source 112 emits light toward the mirror 140, the light reflected by the mirror 140 may be emitted to at least a portion of the surface of the mirror 140. As described above, while the mirror 140, which is driven by the electromagnetic force, is being rotated clockwise or counterclockwise about the first rotating shaft 142, the mirror 140 may emit the light that entered the surface of the mirror 140 toward an external object (e.g., toward a distance measurement target in the LIDAR system) within a certain angle range (a). The scanning device 100 having the configuration described above may be operated as a uniaxial scanning device.

The scanning device 100 may further include a second rotating shaft 130 connected to both ends of the first support 120 in a direction orthogonal to the radial direction of the mirror 140 and rotatably supporting the first support 120 so that the first support 120 can be rotated in a direction orthogonal to the radial direction of the mirror 140, and a second support 110 connected to the second rotating shaft 130 and configured to support the first support 120 through the second rotating shaft 130. In this example, the second rotating shaft 130 may include a bearing configured to be rotatable with respect to the second support 110 and/or a spring or polyamide film 132 configured to provide the first support 120 with the restoring force torque.

A second permanent magnet 160 magnetized in a direction orthogonal to the radial direction of the mirror 140 may be coupled to a lower end of the first support 120. In addition, the scanning device 100 may further include a second electromagnetic field generator 180 that generates an electromagnetic force directed toward the second permanent magnet 160 or an electromagnetic force directed away from the second permanent magnet 160, according to a driving signal. In this case, the second electromagnetic field generator 180 may be disposed in an opening of the second support 110 and below the mirror 140. In this configuration, the second electromagnetic field generator 180 may generate electromagnetic force directed toward the second permanent magnet 160 coupled to the lower end of the first support 120, or may generate an electromagnetic force directed away from the second permanent magnet 160, according to a driving signal input from the controller. That is, the second electromagnetic field generator may generate an electromagnetic field directed toward the second permanent magnet, in which the polarity of the electromagnetic field changes according to the driving signal. As a result, the first support 120 may be rotated clockwise or counterclockwise about the second rotating shaft 130.

As described above, while the mirror 140, which is driven by the electromagnetic force, is rotated clockwise or counterclockwise about the first rotating shaft 142, the first support 120, which is driven by the electromagnetic force, may also be rotated clockwise or counterclockwise about the second rotating shaft 130 and emit the light that entered the surface of the mirror 140 toward an external object (e.g., toward a distance measurement target in the LIDAR system) within a certain angular range (a). The scanning device 100 having the configuration described above can operate as a biaxial scanning device.

According to the examples described above, by using the electromagnetic field generator that generates electromagnetic field with varying polarity with respect to the permanent magnet coupled to one side of the mirror, it is possible to drive the mirror with a larger driving force than the related scanning device that uses the MEMS mirror. Accordingly, the scanning device can efficiently drive a mirror having a large area at high speed.

In addition, according to the examples described above, the uniaxial scanning device can be implemented through a simple manufacturing process, by using the electromagnetic field generator that generates an electromagnetic field of which polarity changes with respect to the permanent magnet coupled to one side of the mirror. In addition, since the scanning device uses a simple mirror driving structure, the scanning device can be easily miniaturized and a control circuit for driving the mirror can be simplified.

According to the examples described above, the rotating shaft for rotatably connecting the mirror to the support can be formed of a polyamide film. In general, polyamide has very low reflection of light compared to components made of metal (e.g., aluminum, nickel, and the like) used in the existing MEMS mirrors. Therefore, even when the size of a beam of light incident on the mirror exceeds the size of the mirror, reflection of light by the rotating shaft connected to the mirror can be reduced. In addition, since light is reflected only by the mirror, a collimating optical system for adjusting the size of the beam of light can be simplified.

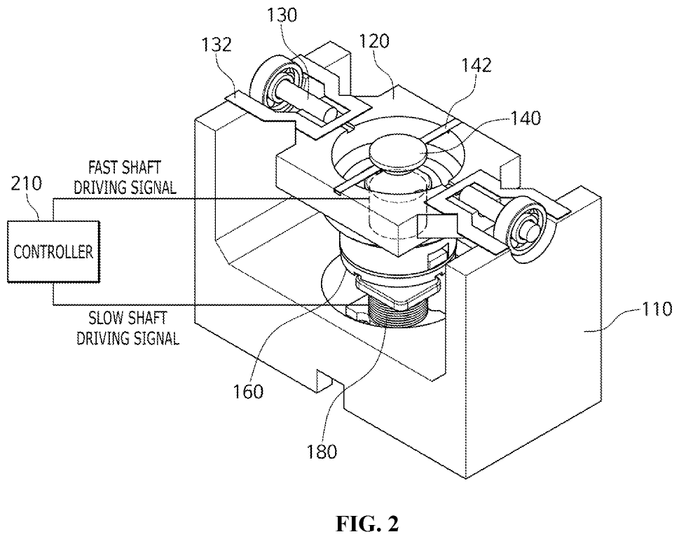

FIG. 2 is a perspective view showing a detailed configuration of a scanning device for driving a mirror in a biaxial direction with electromagnetic force.

As shown, a first permanent magnet (not shown) magnetized in a radial direction of the mirror 140 may be coupled to a lower end of the mirror 140. In addition, a first electromagnetic field generator 150 which is disposed in the opening of the first support 120 and below the mirror 140 may generate an electromagnetic force directed toward the first permanent magnet coupled to the lower end of the mirror 140, or may generate an electromagnetic force directed away from the first permanent magnet, according to a driving signal input from a controller 210. As a result, the mirror 140 may be rotated clockwise or counterclockwise about the first rotating shaft 142. In this case, the driving signal input from the controller 210 to the first electromagnetic field generator 150 may be a sine wave driving signal having a relatively high frequency (hereinafter, also referred to as a “FAST shaft driving signal”).

Meanwhile, the second permanent magnet 160 magnetized in a direction orthogonal to the radial direction of the mirror 140 may be coupled to the lower end of the first support 120. In addition, the second electromagnetic field generator 180 may be disposed in the opening of the second support 110 and below the mirror 140, in which the second electromagnetic field generator 180 generates an electromagnetic force directed toward the second permanent magnet 160 or an electromagnetic force directed away from the second permanent magnet 160, according to a driving signal. In this configuration, the second electromagnetic field generator 180 may generate the electromagnetic force directed toward the second permanent magnet 160 coupled to the lower end of the first support 120 or generate the electromagnetic force directed away from the second permanent magnet 160, according to a driving signal input from the controller 210. As a result, the first support 120 may be rotated clockwise or counterclockwise about the second rotating shaft 130. In this case, the driving signal input from the controller 210 to the second electromagnetic field generator 180 may be a sine wave driving signal having a relatively low frequency (hereinafter, also referred to as a “SLOW shaft driving signal”).

As described above, while the mirror 140, which is driven by the electromagnetic force, is rotated clockwise or counterclockwise in a small cycle (that is, at a high frequency) about the first rotating shaft 142, the first support 120, which is driven by the electromagnetic force may also be rotated clockwise or counterclockwise in a greater cycle (that is, at a lower frequency) about the second rotating shaft 130 and emit the light that entered the surface of the mirror 140 toward an external object (e.g., toward a distance measurement target in the LIDAR system) within a certain angular range (a). The scanning device 100 having the configuration described above can operate as a biaxial scanning device.

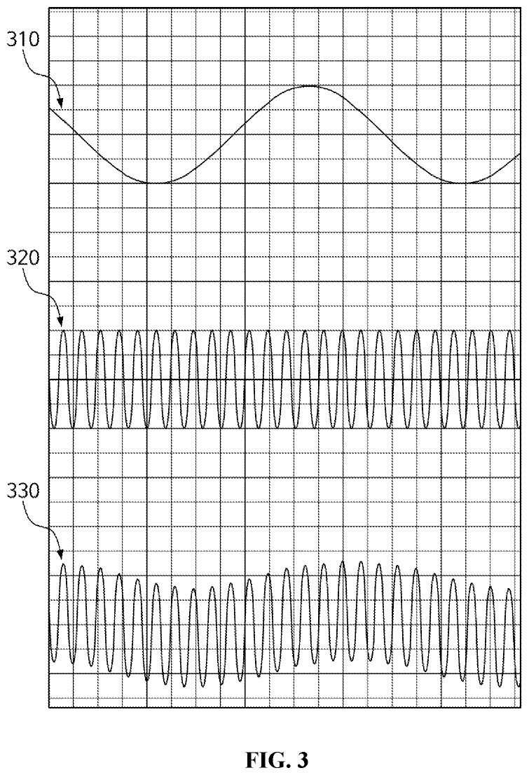

FIG. 3 is a graph showing an example of a driving signal generated by a controller to drive a scanning device in a biaxial direction.

The controller of the scanning device (e.g., the controller 210 of FIG. 2) may provide a sine wave driving signal having a high frequency to the first electromagnetic field generator (e.g., to the first electromagnetic field generator 150 of FIG. 2). For example, as shown in FIG. 3, the controller may provide a FAST shaft driving signal, that is a sine wave 320 having a high frequency, to the first electromagnetic field generator so as to change the direction of the electromagnetic field (or electromagnetic force) generated toward the permanent magnet coupled to one surface of the mirror by the first electromagnetic field generator, according to the corresponding frequency. As a result, according to the frequency of the driving signal, the mirror may change the direction of rotation about the first rotating shaft (e.g., about the first rotating shaft 142 of FIG. 2) to clockwise or counterclockwise rotation.

Meanwhile, the controller of the scanning device may provide a sine wave driving signal having a low frequency to the second electromagnetic field generator (e.g., to the second electromagnetic field generator 180 of FIG. 2). For example, as shown in FIG. 3 , the controller may provide the SLOW shaft driving signal, that is, a sine wave 310 having a lower frequency than the sine wave 320 to the second electromagnetic field generator so as to change the direction of the electromagnetic field (or electromagnetic force) that is generated toward the second permanent magnet (e.g., the second permanent magnet 160 of FIG. 2) coupled to the lower end of the first support (e.g., the first support 120 of FIG. 2) by the second electromagnetic field generator, according to the corresponding frequency. As a result, according to the frequency of the driving signal, the first support may change the direction of rotation about the second rotating shaft (e.g., about the second rotating shaft 130 of FIG. 2) to clockwise or counterclockwise rotation.

The driving signals of the sine waves 320 and 310 provided by the controller of the scanning device to the first electromagnetic field generator and the second electromagnetic field generator respectively may be expressed by Expressions 1 and 2 below, respectively.

sin(a*x) Expression 1:

sin(x) Expression 2:

where, “x” may represent a phase value, and “a” may represent a frequency multiplication of the FAST shaft driving signal with respect to the SLOW shaft driving signal.

In another example, the driving signals of the sine waves 330 and 310 provided by the controller of the scanning device to the first electromagnetic field generator and the second electromagnetic field generator respectively may be expressed by Expression 3 below and Expression 2 described above, respectively.

$$sin ( a * x ) - s * sin ( x + d ) \qquad Expression 3$$

where, “s” may represent the ratio of the amplitude of the SLOW shaft driving signal reflected to the FAST shaft driving signal, and “d” may represent the delay time of the SLOW shaft driving signal reflected to the FAST shaft driving signal. In this way, the controller of the scanning device may set the sine wave driving signals 330 and 310 provided to the first electromagnetic field generator and the second electromagnetic field generator respectively, so as to suppress the mutual interference effect between electromagnetic fields that may occur in a structure in which two electromagnetic field generators are stacked vertically as shown in FIGS. 1 and 2.

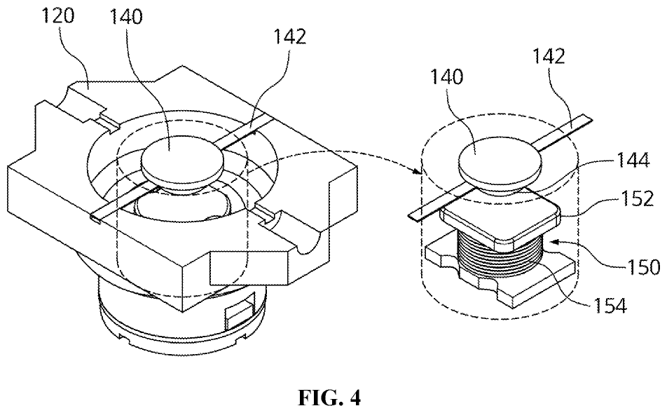

FIG. 4 is a perspective view showing a detailed configuration of a scanning device for driving a mirror in a uniaxial direction with electromagnetic force.

As shown, a first permanent magnet 144 magnetized in a radial direction of the mirror 140 may be coupled to the lower end of the mirror 140 rotatably supported by the first support 120 through the first rotating shaft 142. In addition, the first electromagnetic field generator 150 disposed in the opening of the first support 120 and below the mirror 140 may generate the electromagnetic field toward the first permanent magnet 144 coupled to the lower end of the mirror 140, in which the polarity of the generated electromagnetic field changes according to a driving signal input from the controller. As a result, the mirror 140 may be rotated clockwise or counterclockwise about the first rotating shaft 142.

The electromagnetic field generator 150 may include a core 152 having a central axis orthogonal to the surface of the first permanent magnet 144, and a coil 154 configured to be wound around the core 152 and to which a driving signal transmitted from the controller is applied.

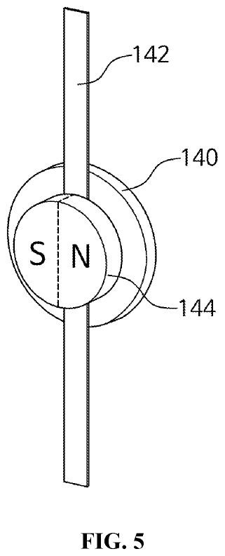

FIG. 5 is a perspective view showing a configuration of a mirror included in a scanning device and a permanent magnet coupled to the mirror.

As shown, the first permanent magnet 144 magnetized in the radial direction of the mirror 140 may be coupled to the lower end of the mirror 140 rotatably supported by the first support through the first rotating shaft 142.

If the first permanent magnet 144 is divided into a first side and a second side opposite to the first side with respect to a line in the radial direction of the mirror 140, the first side may be magnetized to an S pole, and the second side may be magnetized to an N pole.

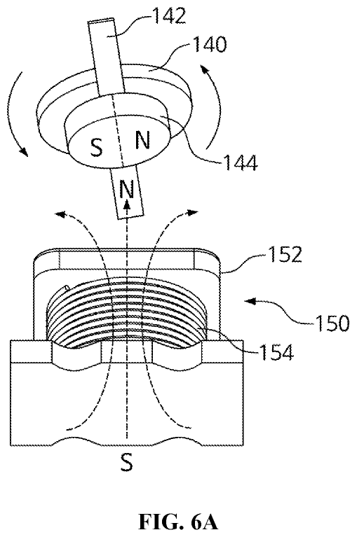

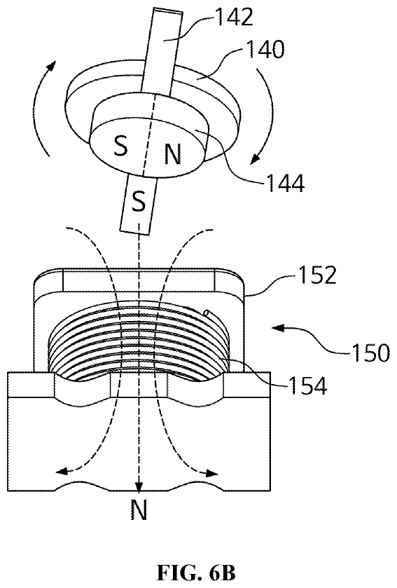

FIGS. 6A and 6B are diagrams illustrating a method for driving a mirror in a uniaxial direction with electromagnetic force in a scanning device.

As shown in FIGS. 6A and 6B, for example, if a sine wave current signal is applied to the first electromagnetic field generator 150, an electromagnetic field may be generated with its polarity changed in the direction of the central axis of the core 152 wound around the coil 154 of the first electromagnetic field generator 150.

As shown in FIG. 6A, if an electromagnetic field having N polarity is formed from the core 152 of the first electromagnetic field generator 150 toward the first permanent magnet 144 coupled to the lower end of the mirror 140, the portion of the first permanent magnet 144 magnetized to the N pole may be rotated in a direction away from the first electromagnetic field generator 150. Conversely, as shown in FIG. 6B, if an electromagnetic field having S polarity is formed from the core 152 of the first electromagnetic field generator 150 toward the first permanent magnet 144 coupled to the lower end of the mirror 140, the portion of the first permanent magnet 144 magnetized to the S pole may be rotated in a direction away from the first electromagnetic field generator 150.

As described above, the first electromagnetic field generator 150 disposed below the mirror 140 may generate an electromagnetic field toward the first permanent magnet 144 coupled to the lower end of the mirror 140, in which the polarity of the electromagnetic field changes according to a driving signal input from the controller. The mirror 140 may be alternately rotated clockwise or counterclockwise about the first rotating shaft 142 according to the polarity of the electromagnetic field that is changed as described above.

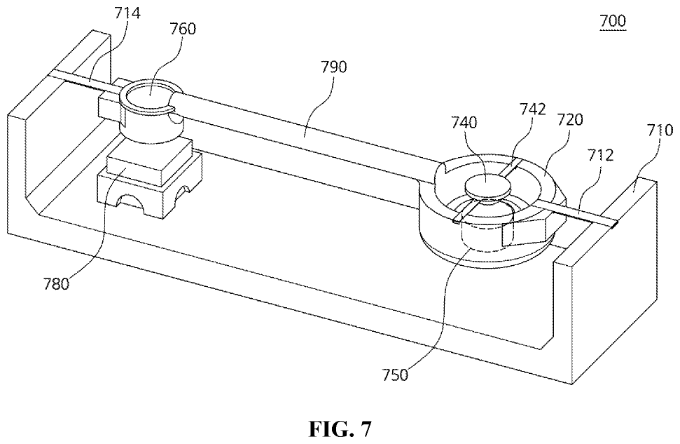

FIG. 7 is a perspective view showing a configuration of a scanning device driven with electromagnetic force.

A scanning device 700 driven with electromagnetic force may include a mirror 740 configured to reflect incident light, a first rotating shaft 742 connected to both ends of the mirror 740 in the radial direction and rotatably supporting the mirror 740, and a first support 720 connected to the first rotating shaft 742 and configured to support the mirror 740 through the first rotating shaft 742. In this case, the first rotating shaft 742 may be formed of a spring or a polyamide film configured to provide restoring force torque to the mirror 740. In addition, the scanning device 700 may further include a first electromagnetic field generator 750 that generates an electromagnetic force directed toward the mirror 740 or an electromagnetic force directed away from the mirror 740, according to a driving signal.

A first permanent magnet (not shown) magnetized in a radial direction of the mirror 740 may be coupled to a lower end of the mirror 740. In addition, the first electromagnetic field generator 750 may be disposed in an opening of the first support 720 and below the mirror 740. In this configuration, the first electromagnetic field generator 750 may generate an electromagnetic field toward the first permanent magnet coupled to the lower end of the mirror 740, in which the polarity of the electromagnetic field is changed according to a driving signal input from a controller (not shown). According to the electromagnetic field with the varying polarity, the mirror 740 may be rotated clockwise or counterclockwise about the first rotating shaft 742.

As described above, while the mirror 740, which is driven by the electromagnetic force, is being rotated clockwise or counterclockwise about the rotating shaft 742, the mirror 740 may emit the light that entered the surface of the mirror 140 toward an external object (e.g., toward a distance measurement target in the LIDAR system) within a certain angle range. The scanning device 700 having the configuration described above may be operated as a uniaxial scanning device.

The scanning device 700 may further include a third rotating shaft 712 connected to one end of the first support 720 in a direction orthogonal to the radial direction of the mirror 740 and for rotatably supporting the first support 720 so that the first support 720 can be rotated in a direction orthogonal to the radial direction of the mirror 740. In this example, the third rotating shaft 712 may include a bearing configured to be rotatable with respect to the first support 720 and/or a spring or polyamide film configured to provide the first support 720 with the restoring force torque.

In addition, the scanning device 700 may further include a third permanent magnet 760 magnetized in a direction orthogonal to the radial direction of the mirror 740, and a third electromagnetic field generator 780 that generates an electromagnetic force directed toward the third permanent magnet 760 or an electromagnetic force directed away from the third permanent magnet 760, according to a driving signal. The third permanent magnet 760 and the first support 720 may be fixedly connected to each other through a cylindrical or rod-shaped connection part 790.

One end of the third permanent magnet 760 may be connected to a third support 710 through a fourth rotating shaft 714 so as to be rotatable in a direction orthogonal to the radial direction of the mirror 740. That is, the third support 710 may be configured to support the third permanent magnet 760 and the first support 720 through the third rotating shaft 712 and the fourth rotating shaft 714.

As described above, while the mirror 740, which is driven by the electromagnetic force, is rotated clockwise or counterclockwise about the rotating shaft 742, the first support 720, which is driven by the electromagnetic force, may also be rotated clockwise or counterclockwise about the rotating shaft 712, 714 and emit the light that entered the surface of the mirror 740 toward an external object (e.g., toward a distance measurement target in the LIDAR system) within a certain angular range. The scanning device 700 having the configuration described above can operate as a biaxial scanning device.

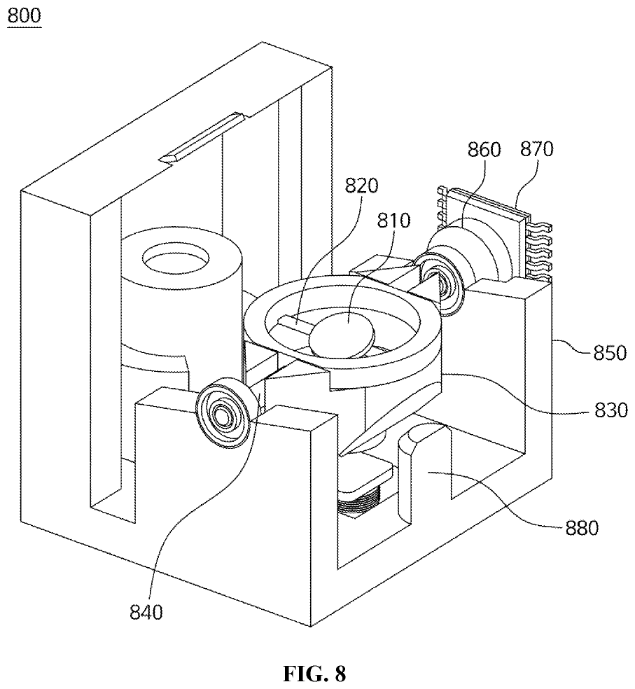

FIG. 8 is a perspective view showing an example of a configuration for controlling a second rotating shaft of a scanning device.

A scanning device 800 driven with electromagnetic force may include a mirror 810 configured to reflect incident light, a first rotating shaft 820 connected to both ends of the mirror 810 in the radial direction and rotatably supporting the mirror 810, and a first support 830 connected to the first rotating shaft 820 and configured to support the mirror 810 through the first rotating shaft 820. In addition, the scanning device 800 may further include a second rotating shaft 840 connected to both ends of the first support 830 in a direction orthogonal to the radial direction of the mirror 810 and rotatably supporting the first support 830 so that the first support 830 can be rotated in a direction orthogonal to the radial direction of the mirror 810, and a second support 850 connected to the second rotating shaft 840 and configured to support the first support 830 through the second rotating shaft 840.

The scanning device 800 may further include an angle detection unit 860 connected to one end of the second rotating shaft 840 and detecting a rotation angle of the second rotating shaft 840. In this case, the angle detection unit 860 may be a magnet that is magnetized in a radial direction of the second rotating shaft 840. In addition, the scanning device 800 may further include a magnetic encoder 870 that controls driving of the second rotating shaft 840 based on the rotation angle of the second rotating shaft 840 received from the angle detection unit 860. In this case, the magnetic encoder 870 may be spaced apart from the angle detection unit 860 and measure the rotation angle of the second rotating shaft 840 detected by the angle detection unit 860. For example, the magnetic encoder 870 may measure the rotation angle of the second rotating shaft 840 based on the rotation degree of the magnet of the angle detection unit 860. Additionally, the magnetic encoder 870 may transmit the rotation angle of the second rotating shaft 840 to the controller (e.g., to the controller 210 of FIG. 2), thereby controlling the driving of the second rotating shaft 130 through the SLOW shaft driving signal.

The second support 850 may include a reference rod 880 for angle zero point adjustment, which is spaced apart from the first support 830 and protrudes upward from a lower end of the second support 850. In this case, the magnetic encoder 870 may set, as a zero point, the rotation angle of the second rotating shaft 840 when the first support 830 contacts the reference rod 880 for angle zero point adjustment. For example, when the scanning device 800 starts operating, the first support 830 may be rotated to come into contact with the reference rod 880 for zero point adjustment, such that the magnetic encoder 870 may set the zero point of the rotation angle of the second rotating shaft 840.

According to the examples described above, by using the electromagnetic field generator that generates electromagnetic field with varying polarity with respect to the permanent magnet coupled to one side of the mirror, it is possible to drive the mirror with a larger driving force than the related scanning device that uses the MEMS mirror. Accordingly, the scanning device can efficiently drive a mirror having a large area at high speed.

In addition, according to the examples described above, the uniaxial scanning device can be implemented through a simple manufacturing process, by using the electromagnetic field generator that generates an electromagnetic field of which polarity changes with respect to the permanent magnet coupled to one side of the mirror. In addition, since the scanning device uses a simple mirror driving structure, the scanning device can be easily miniaturized and a control circuit for driving the mirror can be simplified.

According to the examples described above, the rotating shaft for rotatably connecting the mirror to the support can be formed of a polyamide film. In general, polyamide has very low reflection of light compared to components made of metal (e.g., aluminum, nickel, and the like) used in the existing MEMS mirrors. Therefore, even when the size of a beam of light incident on the mirror exceeds the size of the mirror, reflection of light by the rotating shaft connected to the mirror can be reduced. In addition, since light is reflected only by the mirror, a collimating optical system for adjusting the size of the beam of light can be simplified.

The scanning device according to various examples described above with reference to FIGS. 1 to 7 may be used in various applications, including LIDAR sensors or LIDAR scanning devices, head-up displays, scanning projectors, laser printers and so on. If the scanning device for a LIDAR scanning device, the LIDAR scanning device may further include a reception unit configured to receive light reflected from the object, if the light reflected from the scanning device is emitted to the object. The LIDAR scanning device may analyze the light received through the reception unit to measure the distance to an object, direction, speed, and the like.

While certain embodiments of the present disclosure have been described herein, it will be understood that those skilled in the art will be able to make modifications and changes in various ways by adding, changing, deleting, or adding elements within the scope that does not depart from the spirit of the present disclosure described in the claims, which is also included within the scope of the present disclosure.

1. A scanning device driven with electromagnetic force, the scanning device comprising:
a mirror configured to reflect incident light;
a first rotating shaft connected to both ends of the mirror in a radial direction of the mirror and configured to allow the mirror to be rotated around a first axis parallel to the radial direction;
a first support connected to the first rotating shaft and configured to support the mirror through the first rotating shaft;
a first permanent magnet coupled to the mirror and magnetized in the radial direction of the mirror; and
a first electromagnetic field generator configured to generate a first electromagnetic field with respect to the first permanent magnet, wherein a polarity of the first electromagnetic field changes according to a first driving signal.

2. The scanning device according to claim 1, wherein the first support comprises:
a mirror support connected to the first rotating shaft and supporting the mirror connected to the first rotating shaft; and
an opening for receiving the first electromagnetic field generator disposed below the mirror.

3. The scanning device according to claim 1, further comprising:
a second rotating shaft connected to both ends of the first support in a direction orthogonal to the radial direction of the mirror and configured to allow the first support to be rotated around a second axis parallel to the direction orthogonal to the radial direction of the mirror;
a second support connected to the second rotating shaft and configured to support the first support through the second rotating shaft;
a second permanent magnet coupled to a lower end of the first support and magnetized in the direction orthogonal to the radial direction of the mirror; and
a second electromagnetic field generator configured to generate a second electromagnetic field with respect to the second permanent magnet, wherein a polarity of the second electromagnetic field changes according to a second driving signal.

4. The scanning device according to claim 3, wherein the second rotating shaft comprises:
a bearing configured to be rotatable with respect to the second support; and
an elastic member configured to provide the first support with a restoring force torque.

5. The scanning device according to claim 4, the elastic member comprises at least one of:
a spring; or
a polyamide film.

6. The scanning device according to claim 1, wherein the first electromagnetic field generator comprises:
a core having a central axis orthogonal to a surface of the first permanent magnet; and
a coil configured to be wound around the core, wherein the first driving signal is applied to the coil.

7. The scanning device according to claim 1, further comprising a laser light source configured to emit laser light toward the mirror.

8. The scanning device according to claim 1, further comprising a controller configured to generate the first driving signal to cause an electromagnetic field toward the first permanent magnet.

9. The scanning device according to claim 1, wherein the first rotating shaft comprises an elastic member configured to provide the mirror with a restoring force torque.

10. The scanning device according to claim 1, further comprising:
a third permanent magnet magnetized in a direction orthogonal to the radial direction of the mirror;
a third electromagnetic field generator configured to generate a third electromagnetic field with respect to the third permanent magnet, wherein a polarity of the third electromagnetic field changes according to a third driving signal;
a connection part fixedly connecting the third permanent magnet and the first support;
a third rotating shaft connected to one end of the first support in the direction orthogonal to the radial direction of the mirror and configured to allow the first support to be rotated;
a fourth rotating shaft connected to one end of the third permanent magnet in the direction orthogonal to the radial direction of the mirror and configured to allow the third permanent magnet to be rotated; and
a third support connected to the third rotating shaft and the fourth rotating shaft and configured to support the third permanent magnet and the first support.

11. The scanning device according to claim 3, further comprising:
an angle detection unit connected to one end of the second rotating shaft and configured to detect a rotation angle of the second rotating shaft; and
a magnetic encoder configured to control driving of the second rotating shaft based on the detected rotation angle of the second rotating shaft.

12. The scanning device according to claim 11, wherein the second support comprises a reference rod for angle zero point adjustment, wherein the reference rod is spaced apart from the first support and protrudes upward from a lower end of the second support; and
wherein the magnetic encoder is configured to set, as a zero point, the rotation angle of the second rotating shaft when the first support contacts the reference rod.

13. A light detection and ranging (LIDAR) scanning device comprising:
the scanning device according to claim 1; and
a reception unit configured to receive light reflected from an object, if the light reflected from the mirror is emitted to the object.
